(19) United States
(12) Patent Application Publication
(10) Pub. No.: US 2014/0184562 A1
(43) Pub. Date: Jul. 3, 2014

(54) CAPACITIVE TOUCH APPARATUS AND TOUCH SENSING METHOD THEREOF

(71) Applicants: Ting-Yu Chang, Kaohsiung County (TW); Hsiao-Hui Liao, Taichung City (TW); Ching-Fu Hsu, Taichung City (TW)

(72) Inventors: Ting-Yu Chang, Kaohsiung County (TW); Hsiao-Hui Liao, Taichung City (TW); Ching-Fu Hsu, Taichung City (TW)

(73) Assignee: WINTEK CORPORATION, Taichung City (TW)

(21) Appl. No.: 14/140,569

(22) Filed: Dec. 26, 2013

(30) Foreign Application Priority Data
Dec. 28, 2012 (TW) 101151081

(51) Int. Cl. G06F 3/041; G06F 3/044

(52) U.S. Cl. CPC G06F 3/0416; G06F 3/044
USPC 345/174

(57) ABSTRACT

A capacitive touch apparatus is provided, and which includes a capacitive touch display panel, at least a touch sensing circuit and a judgment unit. The capacitive touch display panel has at least an inductive capacitor. The touch sensing circuit is coupled to the inductive capacitor, and configured to store a one-time charging voltage and to perform a plurality of discharges, through the inductive capacitor, on the one-time charging voltage by utilizing a plurality of switches until the one-time charging voltage is discharged to a predetermined reference voltage. The judgment unit is coupled to the touch sensing circuit, and configured to count a discharging time for discharging the one-time charging voltage to the predetermined reference voltage, and to determine whether a touch event has occurred or not by comparing the discharging time with a predetermined time.

### CROSS-REFERENCE TO RELATED APPLICATION

This application claims the priority benefit of Taiwan application serial no. 101151081, filed on Dec. 28, 2012. The entirety of the above-mentioned patent application is hereby incorporated by reference herein and made a part of this specification.

### BACKGROUND OF THE INVENTION

1. Field of the Invention

The present invention generally relates to a touch technology, and more particularly, to a capacitive touch apparatus and a touch sensing method thereof.

2. Description of Related Art

With the rapid development in technology, electronic apparatus are becoming increasingly popular. For easy to carry, the electronic apparatus has become more and more compact. Therefore, those skilled in the art are strived for constantly improving the power consumption of the electronic apparatuses, while the power consumption of the display unit takes up a considerable proportion against overall power consumed by the electronic apparatus.

Additionally, electronic apparatus having a touch panel are the most popular consumer electronic products, where the mainstreams of the touch panel for sensing touch are a resistive-type and a capacitive type.

The resistive-type touch panel has shortcomings of poor light transmittance, poor durability, lower accuracy and other shortcomings, so it is more suitable for low-end consumer electronic products.

The capacitive-type touch panel has advantages of better sensitivity, better stability, less assembling parts and higher accuracy, so it is more suitable for high-end consumer electronic products.

However, whether resistive-type or capacitive-type touch panel, the topic of how to accurately determine/sense the position of a touch (touch to select) on the touch panel under a low power consumption condition is one of the researching topics for those skilled in the art strive for.

### SUMMARY OF THE INVENTION

Accordingly, an embodiment of the invention set forth a capacitive touch apparatus, which includes: a capacitive touch display panel, at least a touch sensing circuit, and a judgment unit. The capacitive touch display panel has at least an inductive capacitor. The touch sensing circuit is coupled to the inductive capacitor, and configured to store a one-time charging voltage and the one-time charging voltage is repeatedly discharged through the inductive capacitor by utilizing a plurality of switches until the one-time charging voltage is discharged to a predetermined reference voltage. The judgment unit is coupled to the touch sensing circuit, and configured to count a discharging time for discharging the one-time charging voltage to the predetermined reference voltage and determine whether a touch event has occurred or not by comparing the discharging time with a predetermined time.

According to an embodiment of the invention, the inductive capacitor changes along with the occurrence of the touch event.

According to an embodiment of the invention, the touch sensing circuit may include: a first switch, a second switch, a third switch and a given capacitor. The first switch has a first terminal coupled to a system voltage, a second terminal coupled to an output terminal, and a control terminal configured to receive a first control signal. In addition, the output terminal is further coupled to the judgment unit. The given capacitor has a first terminal coupled to the output terminal, and a second terminal coupled to a first terminal of the inductive capacitor. The second switch has a first terminal coupled to the output terminal, a second terminal coupled to a ground potential and a second terminal of the inductive capacitor, and a control terminal configured to receive a second control signal. The third switch has a first terminal coupled to the first terminal of the inductive capacitor, a second terminal coupled to the ground potential, and a control terminal configured to receive a third control signal.

According to an embodiment of the invention, the given capacitor is substantially greater than the inductive capacitor.

According to an embodiment of the invention, during a first operation phase (stage) of the touch sensing circuit, the first switch is turned on in response to the first control signal, the second switch is turned off in response to the second control signal, and the third switch is turned on in response to the third control signal. During a second operation phase of the touch sensing circuit, the first switch is turned off in response to the first control signal, the second switch is turned on in response to the second control signal, and the third switch is turned off in response to the third control signal. During a third operation phase of the touch sensing circuit, the first switch is turned off in response to the first control signal, the second switch is turned off in response to the second control signal, and the third switch is turned on in response to the third control signal. It should be noted that the touch sensing circuit goes into (enters) the first operation phase for one-time. Furthermore, the touch sensing circuit goes into the second operation phase and the third operation phase, alternately, for multiple times until the one-time charging voltage is discharged to the predetermined reference voltage.

According to an embodiment of the invention, during the first operation phase, the given capacitor stores the one-time charging voltage corresponding to the system voltage in response to the first and the third switches that are turned on. During the second operation phase, the given capacitor discharges a portion of charges corresponding to the one-time charging voltage to the inductive capacitor in response to the second switch that is turned on. During the third operation phase, the portion of charges obtained during the second operation phase by the inductive capacitor is discharged to the ground potential in response to the third switch that is turned on, and meanwhile, the judgment unit determines, through the output terminal, whether the one-time charging voltage corresponding to the charges remained in the given capacitor reaches the predetermined reference voltage.

According to an embodiment of the invention, when the judgment unit determines that the discharging time is different from the predetermined time by comparing the discharging time with the predetermined time, then the touch event has occurred. On the contrary, when the judgment unit determines that the discharging time is the same as the predetermined time by comparing the discharging time with the predetermined time, then no touch event has occurred.

According to an embodiment of the invention, the duration of the first operation phase may be substantially greater than the durations of the second and third operation phase, and the durations of the second and the third operation phase may be the same.

According to an embodiment of the invention, when the at least an inductive capacitor of the capacitive touch display panel includes at least M*N inductive capacitors, then the at least a touch sensing circuit of the capacitive touch apparatus includes at least M*N touch sensing circuits. Under such condition, the at least M*N inductive capacitors respectively correspond to the at least M*N touch sensing circuits, where M and N are respectively positive integers greater than 1.

According to an embodiment of the invention, when the at least an inductive capacitor of the capacitive touch display panel includes at least M*N inductive capacitors, then the at least a touch sensing circuit of the capacitive touch display panel includes at least M or N touch sensing circuits. Under such condition, the M or N touch sensing circuits are shared by the M*N inductive capacitors through a multiplexer selection circuit, wherein M and N are respectively positive numbers greater than 1.

According to an embodiment of the invention, the touch sensing circuit may be integrated together with the capacitive touch display panel, or manufactured into a chip-type bounding with the capacitive touch display panel. Furthermore, a displaying part of the capacitive touch display panel may be implemented by an Organic Light Emitting Diode (OLED) display module, a Liquid Crystal Display (LCD) module, or a Plasma Display Panel (PDP) module.

An embodiment of the invention set forth a touch sensing method adapted to the capacitive touch display panel, which includes: providing a given capacitor, and charging the given capacitor for one-time, so that a one-time charging voltage is stored in the given capacitor; performing a plurality of discharges on the one-time charging voltage, through at least an inductive capacitor in the capacitive touch display panel, by utilizing a plurality of switches until the one-time charging voltage is discharged to a predetermined reference voltage; and counting a discharge time for discharging the one-time charging voltage to a predetermined reference voltage, and determining whether a touch event has occurred by comparing the discharging time with the predetermined time. When the discharging time is different from the predetermined time, the touch event has occurred. On the contrary, when the discharging time is the same as the predetermined time, no touch event has occurred.

Accordingly, the embodiments of the invention set forth the concept of one-time charging and multiple discharging on the given capacitor as the basis of implementing the touch sensing scheme. Since the given capacitor is charged for one-time only, the touch sensing scheme set forth by the embodiments of the invention has a characteristic of low power consumption. Alternatively, the hardware elements/components for implementing the touch sensing scheme may be integrated into the capacitive touch display panel, and thus the thickness and costs of the capacitive apparatus are reduced.

In order to make the aforementioned and other objects, features and advantages of this invention comprehensible, embodiment accompanied with figures is described in detail below.

### BRIEF DESCRIPTION OF THE DRAWINGS

The accompanying drawings are included to provide further understanding and are incorporated in and constitute a part of this specification. The drawings illustrate exemplary embodiments and together with the description, serve to explain the principles of the disclosure.

FIG. 1 is a diagram illustrating a capacitive touch apparatus 10 according to an embodiment of the invention.

FIG. 2 is a schematic diagram illustrating an implementation of a touch sensing circuit 103 depicted in FIG. 1.

FIG. 3 is a wave-form diagram illustrating the operations of the touch sensing circuit 103 depicted in FIG. 2.

FIG. 4A is a schematic diagram illustrating the touch sensing circuit 103 depicted in FIG. 2 during a first operation phase (stage) I.

FIG. 4B is a schematic diagram illustrating the touch sensing circuit 103 depicted in FIG. 2 during a second operation phase II.

FIG. 4C is a schematic diagram illustrating the touch sensing circuit 103 depicted in FIG. 2 during a third operation phase III.

FIG. 4D is a schematic diagram illustrating the touch sensing circuit 103 of FIG. 2 manufactured on a pixel array substrate of the touch display panel 101.

FIG. 4E is a schematic diagram illustrating the touch sensing circuit 103 of FIG. 2 manufactured in a chip-type bounding with the capacitive display panel 101 through flexible print circuit FPC.

FIG. 5A is a diagram illustrating a capacitive touch apparatus 10′ according to yet another exemplary embodiment of the invention.

FIG. 5B is a diagram illustrating a capacitive touch apparatus 10″ according to yet another exemplary embodiment of the invention.

FIG. 6 is a flow chart illustrating a touch sensing method adapted to a capacitive touch display panel according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

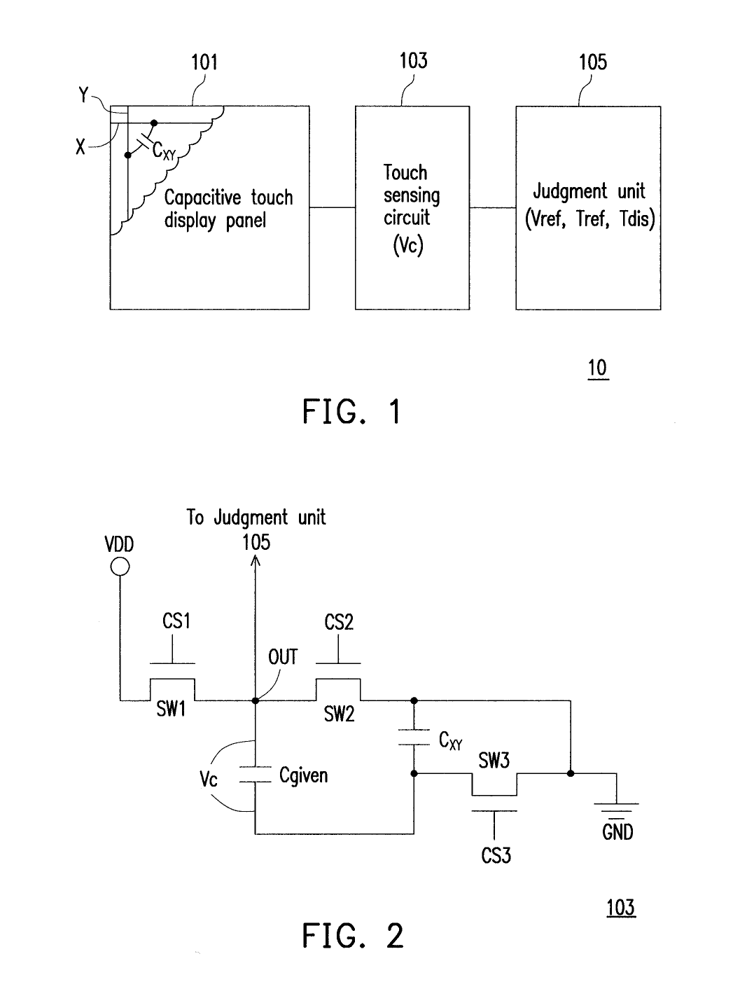

FIG. 1 is a diagram illustrating a capacitive touch apparatus 10 according to an embodiment of the invention. Referring to FIG. 1, the capacitive touch apparatus 10 includes a capacitive touch display panel 101, at least a touch sensing circuit 103, and a judgment unit 105. The capacitive touch display panel 101 has at least an inductive capacitor C_{XY} formed between a scan line X and a sensing line Y. Furthermore, the inductive capacitor C_{XY} changes in response to a touch event, for example, the capacitance of the inductive capacitor C_{XY} decreases, however, it is not limited thereto.

It should be noted that the quantity of the inductive capacitors in the capacitive touch display panel 101 may be configurable according to the practical sensing resolution of the capacitive touch display panel 101. For instance, if the sensing resolution of the capacitive touch display panel 101 is M*N (M and N are positive integers greater than 1), it means that there are M scan lines and N sensing lines within the capacitive touch display panel 101. Under such condition, an intersection of each scan line and each sensing line forms at least one inductive capacitor, so that there are at least M*N inductive capacitors in the capacitive touch display panel 101.

For the ease of illustrating the touch sensing concept set forth in the embodiments of the invention, one inductive capacitor C_{XY} and one touch sensing circuit 103 are utilized for the purpose of illustration and explanation. In addition, a displaying part/section of the capacitive touch display panel 101 may be implemented by an Organic Light Emitting Diode (OLED) display module, a Liquid Crystal Display (LCD) module, or a Plasma Display Panel (PDP) module. However, these implementations are not intended to limit the embodiments of the invention; instead the implementation of the capacitive touch display panel 101 may be implemented according to the requirements of practical application/design.

The touch sensing circuit 103 is coupled to the inductive capacitor C_{XY}, and configured to store a one-time charging voltage Vc. The one-time charging voltage Vc will be repeatedly discharged through the inductive capacitor C_{XY} by utilizing a plurality of switches until the one-time charging voltage Vc is discharged to a predetermined reference voltage Vref.

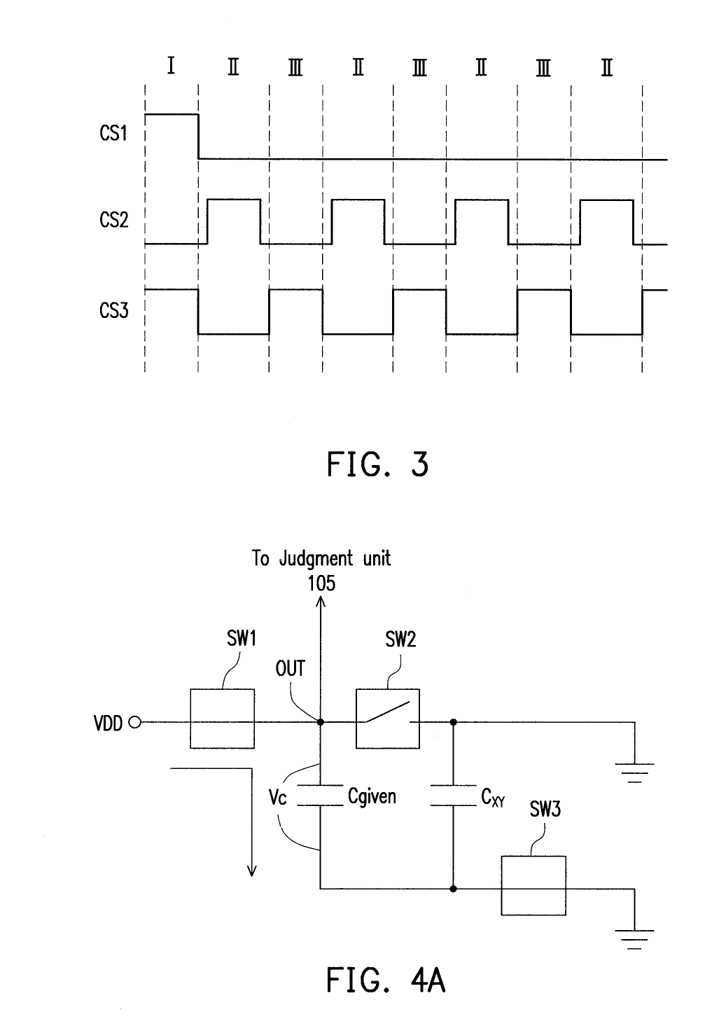

In detail, FIG. 2 is a schematic diagram illustrating the implementation of the touch sensing circuit 103 depicted in FIG. 1. With reference to FIGS. 1 and 2, the touch sensing circuit 103 includes a plurality of switches SW1-SW3 and a given capacitor Cgiven. The switch SW1 has a first terminal coupled to a system voltage VDD, a second terminal coupled to an output terminal OUT, and a control terminal configured to receive a first control signal CS1. In the present embodiment, the output terminal OUT is also coupled to the judgment unit 105.

The given capacitor Cgiven has a first terminal coupled to the output terminal OUT, and a second terminal coupled to a first terminal of the inductive capacitor C_{XY}. In the present embodiment, the given capacitor Cgiven is substantially greater than the inductive capacitor C_{XY}. For instance, the given capacitor Cgiven may be tens or hundreds of times more than the inductive capacitor C_{XY} in capacitance.

A first terminal of the switch SW2 is coupled to the output terminal OUT, a second terminal of the switch SW2 is coupled to a ground potential GND and a second terminal of inductive capacitor C_{XY}, and a control terminal of the switch SW2 is configured to receive a second control signal CS2. The switch SW3 has a first terminal coupled to the first terminal of the inductive capacitor C_{XY}, a second terminal coupled to the ground potential GND, and a control terminal configured to receive a third control signal CS3. In the embodiment, the switches SW1-SW3 may be implemented by N-type transistors, such as N-type MOSFETs, NPN-type BJTs, N-type IGBTs and other controllable switches. However, the embodiments of the invention are not limited thereto.

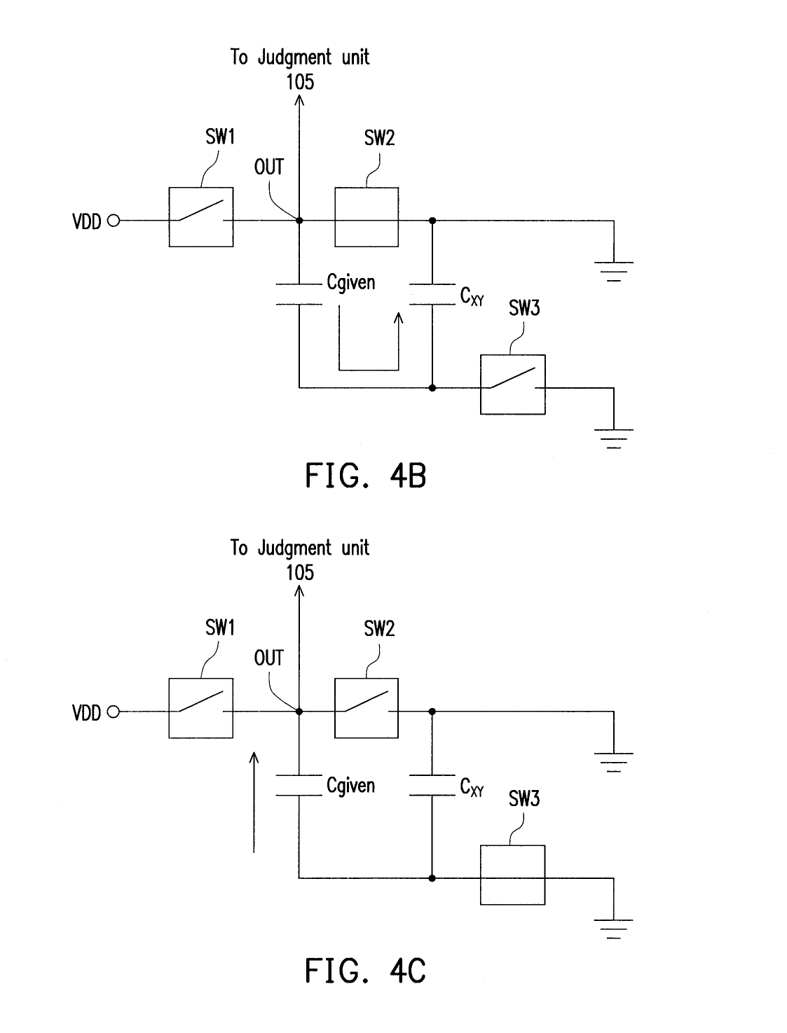

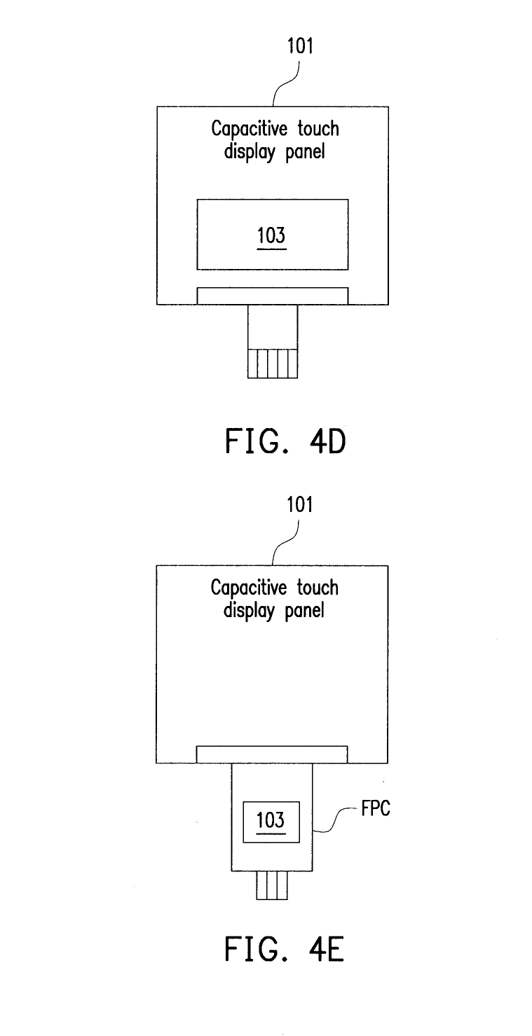

Alternatively, FIG. 3 is a wave-form diagram illustrating the operation of the touch sensing circuit 103 depicted in FIG. 2. With reference to FIG. 1 thru FIG. 3, during a first operation phase (stage) I of the touch sensing circuit 103, as illustrated in FIG. 4A, the switch SW1 is turned on in response to the first control signal CS1, the switch SW2 is turned off in response to the second control signal CS2, and the switch SW3 is turned on in response to the third control signal CS3. Under such condition, during the first operation phase I of the touch sensing circuit 103, the given capacitor Cgiven stores the one-time charging voltage Vc corresponding to the system voltage VDD in response to the switches SW1, SW3 that are turned on (e.g., 3.3V, however, it is not limited thereto).

Furthermore, during a second operation phase II of the touch sensing circuit 103, as illustrated in FIG. 413, the switch SW1 is turned off in response to the first control signal CS1, the switch SW2 is turned on in response to the second control signal CS2, and the switch SW3 is turned off in response to the third control signal CS3. Under such condition, during the second operation phase II of the touch sensing circuit 103, the given capacitor Cgiven discharges a portion of charges corresponding to the one-time charging voltage Vc to the inductive capacitor C_{XY} in response to the switch SW2 that is turned on.

Moreover, during a third operation phase III of the touch sensing circuit 103, as illustrated in FIG. 4C, the switch SW1 is turned off in response to the first control signal CS1, the switch SW2 is turned off in response to the second control signal CS2, and the switch SW3 is turned on in response to the third control signal CS3. Under such condition, during the third operation phase III of the touch sensing circuit 103, the portion of charges obtained in the second operation phase II by the inductive capacitor C_{XY} are completely discharged to the ground potential GND in response to the switch SW3 that is turned on. Meanwhile, through the output terminal OUT, the judgment unit 105 determines whether the one-time charging voltage Vc corresponding to the charges remained in the given capacitor Cgiven reaches the reference voltage Vref (e.g., 2.2V, however, it is not limited thereto).

It should be obvious from FIG. 3 that the touch sensing circuit 103 performs the first operation phase I for one-time only. Next, the touch sensing circuit 103 performs the second operation phase II and the third operation phase III, alternately, for multiple times until the one-time charging voltage Vc stored in the given capacitor Cgiven is discharged to the predetermined reference voltage Vref. It should be noted that the duration of the first operation phase I is much greater than the durations of the second and third operation phases (II, III), so as to ensure that the given capacitor Cgiven is charged to the one-time charging voltage Vc corresponding to the system voltage VDD. Furthermore, the durations of the second and third operation phases (II, III) may be the same substantially, however, it is not limited thereto, and it may be adjusted adaptively according to the requirements of practical application/design.

Alternatively, the judgment unit 105 is coupled to the touch sensing circuit 103, and configured to determine, through the output terminal OUT, whether the one-time charging voltage Vc corresponding to the charges remained in the given capacitor after the plurality of discharges reaches the predetermined reference voltage Vref. Under such condition, the judgment unit 105 may count a discharge time Tdis for discharging the one-time charging voltage Vc stored in the given capacitor to the predetermined reference voltage Vref, and determine whether a touch event has occurred or not by comparing the discharge time Tdis with a predetermined time Tref.

In the present embodiment, since the inductive capacitor C_{XY} changes along with the occurrence of the touch event, such as reduced from 10 pf to 5 pf, but the embodiment is not limited thereto. Under the assumption that no touch event has occurred, the discharging time for discharging the one-time charging voltage Vc stored in the given capacitor (e.g, 600 pf) to the predetermined reference voltage Vref is 500 us (however, it is not limited thereto), then the discharging time Tdis, 500 us, may be utilized as the predetermined time Tref, that is, Tref=500 us.

Alternatively, under the condition that the touch event has occurred, the capacitance of the inductive capacitor C_{XY} decreases from 10 pf to 5 pf along with the occurrence of touch event. Therefore, the discharging time Tdis for discharging the one-time charging voltage Vc stored in the given capacitor Cgiven (e.g., 600 pf) is extended to, for example, 1 ms (however, it is not limited thereto). Accordingly, when the discharging time Tdis is different from the predetermined time Tref (i.e., Tdis≠Tref, compared by the judgment unit 105), the touch event has occurred. On the contrary, when the discharging time Tdis is the same as the predetermined time Tref (i.e., Tdis=Tref), no touch event has occurred.

From the above, the embodiment set forth a concept of one-time charging and multiple discharging of the given capacitor Cgiven as a basis for implementing the proposed touch sensing scheme. Since the given capacitor Cgiven is charged for one-time only, the touch sensing scheme set forth by the embodiments of the invention has a characteristic of low power consumption.

On the other hand, as illustrated in FIG. 4D, the touch sensing circuit 103 may be integrated with a capacitive touch display panel 101 (e.g., integrated to a pixel array substrate of the capacitive touch display panel 101), or, as illustrated in FIG. 4E, the touch sensing circuit 103 may be manufactured into a chip-type bounding together with the capacitive touch display panel 101 through a flexible printed circuit board FPC. Based on the above, the hardware elements/components for implementing the touch sensing scheme set forth by the embodiments of the invention may be integrated into the capacitive touch display panel 101, and therefore, the thickness and costs of the capacitive touch apparatus 10 may be reduced.

It should be noted that the embodiments described above are illustrated with one (or single) inductive capacitor C_{XY} and one (or single) touch sensing circuit 103 as example. However, in other embodiments of the invention, when there is a capacitive touch display panel 101 having at least M*N inductive capacitors (C_{XY}), the capacitive touch apparatus 10 may also have at least M*N touch sensing circuits (103) having similar circuit configuration and operations as the touch sensing circuit illustrated in FIG. 2. In addition, there are at least M*N inductive capacitors that respectively correspond to the at least M*N touch sensing circuits.

Alternatively, when there are at least M*N inductive capacitors (C_{XY}) in the capacitive touch display panel 101, the capacitive touch apparatus 10 may have M or N touch sensing circuits (103) having similar circuit configuration and operations as the touch sensing circuit illustrated in FIG. 2, and the at least M*N inductive capacitors may share M or N touch sensing circuits (103) through a multiplexer (MUX) selection circuit. That is, the number of the touch sensing circuits (103) utilized by the capacitive touch apparatus 10 may be reduced.

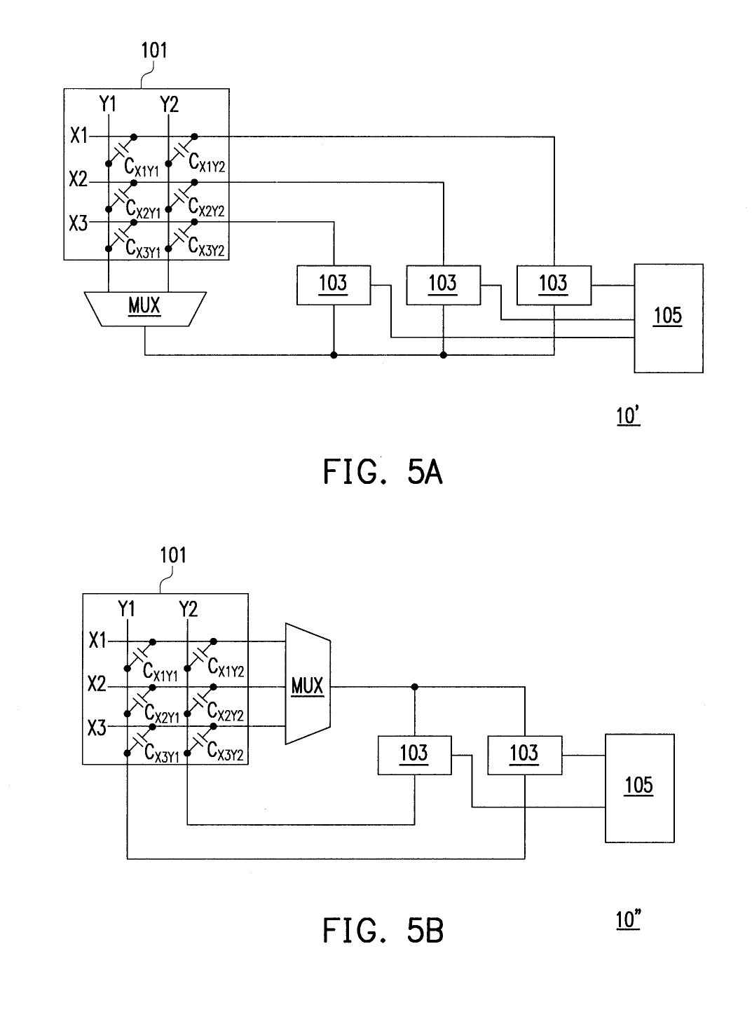

For example, as illustrated in FIG. 5A, if there are 2*3 inductive capacitors (C_{X1Y1}, C_{X1Y2}, C_{X2Y1}, C_{X2Y2}, C_{X3Y1}, C_{X3Y2}) in the capacitive touch display panel 101, that is, at the intersections of each of the scan lines (X1, X2, X3) and each of the sensing lines (Y1, Y2), the capacitive touch apparatus 10′ may only have 3 touch sensing circuits (103) having the circuit configuration and operations similar to the touch sensing circuit illustrated in FIG. 2, and the 2*3 inductive capacitors (C_{X1Y1}, C_{X1Y2}, C_{X2Y1}, C_{X2Y2}, C_{X3Y1}, C_{X3Y2}) may share the aforementioned 3 touch sensing circuits (103) through a multiplexer MUX.

Alternatively, as illustrated in FIG. 5B, if there are 2*3 inductive capacitors (C_{X1Y1}, C_{X1Y2}, C_{X2Y1}, C_{X2Y2}, C_{X3Y1}, C_{X3Y2}), that is, at the intersections of each of the scan lines (X1, X2, X3) and each of the sensing lines (Y1, Y2), the capacitive touch apparatus 10″ may have only 2 touch sensing circuits (103) having the circuit configuration and operations similar to the touch sensing circuit illustrated in FIG. 2, and the 2*3 inductive capacitors (C_{X1Y1}, C_{X1Y2}, C_{X2Y1}, C_{X2Y2}, C_{X3Y1}, C_{X3Y2}) may share the aforementioned 2 touch sensing circuits (103) through a multiplexer MUX.

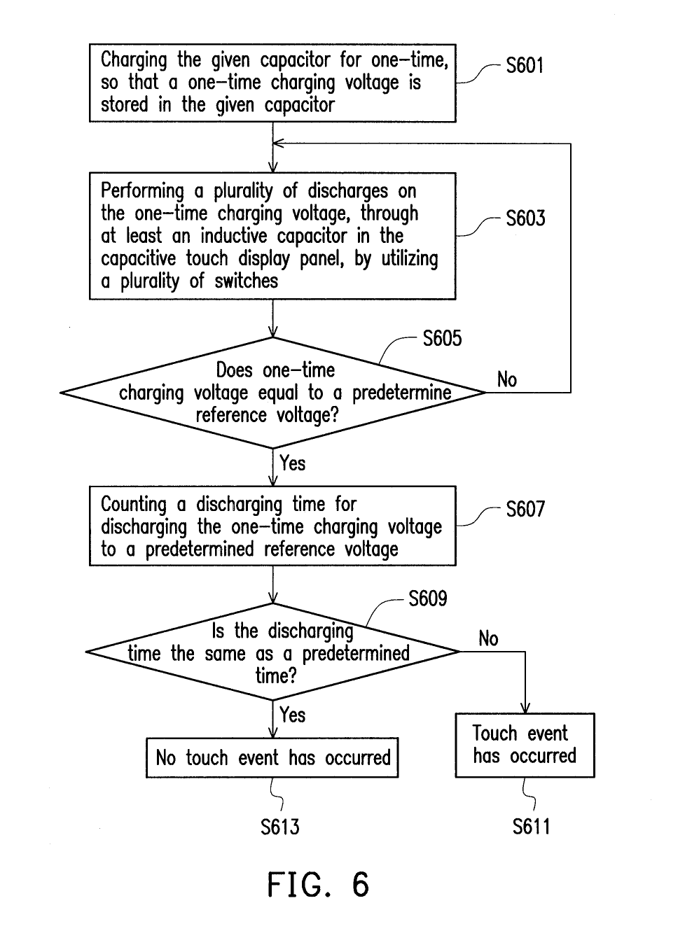

Based on the embodiments described above, FIG. 6 is a flow chart illustrating the touch sensing method adapted to the capacitive touch display panel according to an embodiment of the invention. With reference to FIG. 6, the touch sensing method adapted to the capacitive display panel of the present embodiment includes the following steps:

Providing a given capacitor, and charging the given capacitor for one-time so as to make that a one-time charging voltage is stored in the given capacitor (step S601).

Performing a plurality of discharges on the one-time charging voltage, though at least an inductive capacitor of the capacitive touch display panel, by utilizing a plurality of switches until the one-time charging voltage is discharged to a predetermined reference voltage (step S603 and S605).

Counting a discharging time for discharging the one-time charging voltage to the predetermined reference voltage (Step S607).

Comparing the discharging time with a predetermined time (step S609), so as to determine whether a touch event has occurred.

When the discharging time is different from the predetermined time, a touch event has occurred (step S611).

When the discharging time is the same as the predetermined time, no touch event has occurred (step S613).

Accordingly, the embodiments of the invention set forth the concept of one-time charging and multiple discharging on a given capacitor as the basis of implementing the touch sensing scheme. Since the given capacitor is only charged for one-time, the touch sensing scheme set forth by the embodiments of the invention has a characteristic of low power consumption. Alternatively, the hardware elements/components for implementing the touch sensing scheme may be integrated into the capacitive touch display panel, and thus the thickness and costs of the capacitive apparatus are reduced.

Although the present invention has been described with reference to the above embodiments, however, the present invention is not limited thereto. It will be apparent to those skilled in the art that various modifications and variations can be made to the configuration of the disclosure without departing from the scope or spirit of the disclosure. In view of the foregoing, it is intended that the disclosure cover modifications and variations of this disclosure provided they fall within the scope of the following claims and their equivalents.

Furthermore, any of the exemplary embodiments of the invention or the scope of disclosure is not required to attain each and every goals, advantages, or properties. Moreover, the abstract and title of the invention are merely utilized to aid the search of patent applications, and it is not intended to limit the scope of the embodiments of the invention.

What is claimed is:

1. A capacitive touch apparatus, comprising:
a capacitive touch display panel, having at least an inductive capacitor;
at least a touch sensing circuit, coupled to the inductive capacitor, configured to store a one-time charging voltage, wherein the one-time charging voltage is repeatedly discharged through the inductive capacitor by utilizing a plurality of switches until the one-time charging voltage is discharged to a predetermined reference voltage; and
a judgment unit, coupled to the touch sensing circuit, configured to count a discharging time for discharging the one-time charging voltage to the predetermined reference voltage, and to determine whether a touch event has occurred or not by comparing the discharging time with a predetermined time.

2. The capacitive touch apparatus as claimed in claim 1, wherein the inductive capacitor changes along with the occurrence of the touch event.

3. The capacitive touch apparatus as claimed in claim 1, wherein the touch sensing circuit comprises:
a first switch, having a first terminal coupled to a system voltage, a second terminal coupled to an output terminal, and a control terminal configured to receive a first control signal, wherein the output terminal is further coupled to the judgment unit;
a given capacitor, having a first terminal coupled to the output terminal, and a second terminal coupled to a first terminal of the inductive capacitor;
a second switch, having a first terminal coupled to the output terminal, a second terminal coupled to a ground potential and a second terminal of the inductive capacitor, and a control terminal configured to receive a second control signal; and
a third switch, having a first terminal coupled to the first terminal of the inductive capacitor, a second terminal coupled to the ground potential, and a control terminal configured to receive a third control signal.

4. The capacitive touch apparatus as claimed in claim 3, wherein the given capacitor is substantially greater than the inductive capacitor.

5. The capacitive touch apparatus as claimed in claim 3, wherein:
during a first operation phase of the touch sensing circuit, the first switch is turned on in response to the first control signal, the second switch is turned off in response to the second control signal, and the third switch is turned on in response to the third control signal;
during a second operation phase of the touch sensing circuit, the first switch is turned off in response to the first control signal, the second switch is turned on in response to the second control signal, and the third switch is turned off in response to the third control signal; and
during a third operation phase of the touch sensing circuit, the first switch is turned off in response to the first control signal, the second switch is turned off in response to the second control signal, and the third switch is turned on in response to the third control signal;
wherein the touch sensing circuit enters the first operation phase for one-time only,
wherein the touch sensing circuit enters the second operation phase and the third operation phase for multiple times, alternately, until the one-time charging voltage is discharged to the predetermined reference voltage,
wherein a duration of the first operation phase is substantially greater than a duration of the second operation phase and a duration of the third operation phase,
wherein the durations of the second operation phase and third operation phase are substantially the same.

6. The capacitive touch apparatus as claimed in claim 5, wherein:
during the first operation phase, the given capacitor stores the one-time charging voltage corresponding to the system voltage in response to the first and the third switches that are turned on;
during the second operation phase, the given capacitor discharges a portion of charges corresponding to the one-time charging voltage to the inductive capacitor in response to the second switch that is turned on; and
during the third operation phase, the portion of charges obtained during the second operation phase by the inductive capacitor is discharged to the ground potential in response to the third switch that is turned on, and meanwhile, the judgment unit determines, through the output terminal, whether the one-time charging voltage corresponding to the charges remained in the given capacitor reaches the predetermined reference voltage.

7. The capacitive touch apparatus as claimed in claim 6, wherein:
when the judgment unit determines that the discharging time is different from the predetermined time by comparing the discharging time with the predetermined time, then the touch event has occurred; and
when the judgment unit determines that the discharging time is the same as the predetermined time by comparing the discharging time with the predetermined time, then no touch event has occurred.

8. The capacitive touch apparatus as claimed in claim 1, wherein when the at least an inductive capacitor of the capacitive touch display panel comprises at least M*N inductive capacitors, then the at least a touch sensing circuit of the capacitive touch apparatus similarly comprises at least M*N touch sensing circuits, and the at least M*N inductive capacitors respectively correspond to the at least M*N touch sensing circuits, where M and N are respectively positive integers greater than 1.

9. The capacitive touch apparatus as claimed in claim 1, wherein when the at least an inductive capacitor of the capacitive touch display panel comprises at least M*N inductive capacitors, then the at least a touch sensing circuit of the capacitive touch display panel comprises at least M or N touch sensing circuits, and the M or the N touch sensing circuits are shared by the M*N inductive capacitors through a multiplexer selection circuit, where M and N are respectively positive numbers greater than 1.

10. The capacitive touch apparatus as claimed in claim 1, wherein:
the touch sensing circuit is integrated together with the capacitive touch display panel, or manufactured into a chip-type bounding with the capacitive touch display panel; and
a displaying part of the capacitive touch display panel is implemented by an Organic Light Emitting Diode (OLED) display module, a Liquid Crystal Display (LCD) module, or a Plasma Display Panel (PDP) module.

11. A touch sensing method, adapted a capacitive touch display panel, the touch sensing method comprising:
providing a given capacitor, and charging the given capacitor for one-time, so that a one-time charging voltage is stored in the given capacitor;
performing a plurality of discharges on the one-time charging voltage, through at least an inductive capacitor in the capacitive touch display panel, by utilizing a plurality of switches, until the one-time charging voltage is discharged to a predetermined reference voltage; and
counting a discharging time for discharging the one-time charging voltage to the predetermined reference voltage, and determining whether a touch event has occurred by comparing the discharging time with a predetermined time,
wherein when the discharging time is different from the predetermined time, the touch event has occurred,
wherein when the discharging time is the same as the predetermined time, no touch event has occurred.
